(19) United States
(12) Patent Application Publication
(10) Pub. No.: US 2014/0237351 A1
(43) Pub. Date: Aug. 21, 2014

(54) APPLICATION PROGRAM CONTROL

(71) Applicants: Robert Seidl, Konigsdorf (DE); Gerald Meyer, Puchheim-Bhf (DE); Markus Bauer-Hermann, Munich (DE)

(72) Inventors: Robert Seidl, Konigsdorf (DE); Gerald Meyer, Puchheim-Bhf (DE); Markus Bauer-Hermann, Munich (DE)

(73) Assignee: NOKIA SOLUTIONS AND NETWORKS OY, Espoo (FI)

(21) Appl. No.: 14/240,044

(22) PCT Filed: Aug. 24, 2011
(86) PCT No.: PCT/EP2011/064529

§ 371 Date: Feb. 21, 2014

(51) Int. Cl. G06F 17/22

(52) U.S. Cl. CPC G06F 17/2247
USPC 715/234

(57) ABSTRACT

The present invention relates to application program control, in which a browser 203 receives content 208 from a server 205 and, based on the browser content, transmit a request 209 to a port on a device 202. A response is received 211 to the request from an application 204 associated with the port which indicates that the application 204 is triggered. A second request is transmitted 217 to the port on the device 202 to indicate to the application 204 that the browser 203 will handover control, at least in part, of the device 202 to the application 204.

The present invention relates to application program control and, in particular, to application program control by a browser.

A user device, e.g. a computing device, mobile device, and so on, typically will include one or more browsers which may also be referred to as web browsers. Presently, there are numerous browsers available, for example, well-known browsers include Internet Explorer™, Firefox™, Chrome™, and so on, which enable the user of a user device to, for example, access and interact with information, data, and resources located in the Internet. However, modern browsers include functionality that enables the browser to be used for various functions such as exploring files on the user device, transferring data, enhance user experience, and so on.

In order to enable browsers to provide various functionalities and to enhance the user experience current browsers include browser dependent extensions or so-called plug-ins. Browser specific extensions or plug-ins may include, for example, ActiveX, Javascript, AJAX, Mozilla plug-ins for Firefox, Chrome extensions, and so on. The browser dependent extensions or plug-ins operate within the environment, context and constraints of the specific local browser and therefore effectively operate as part of the local browser.

Accordingly, if the browser is terminated, either on purpose or accidentally, then the functionality provided by the extensions being executed by the browser is also terminated. Furthermore, as the extensions are browser specific a user will not have access to the same functionality in each of the different browsers or even across different user devices using the same browser as different versions of each browser may be implemented on different devices.

For example, if the user device is a mobile device, e.g. a mobile telephone, tablet, etc, then the browsers installed on mobile devices typically have reduced or limited functionality and often lack the ability to be enhanced by any or many extensions which means a user of the mobile device is unable to access the same functionality on their mobile device as they can on their other computing devices, such as laptops, personal computers, etc, as they are not supported by browser versions for the mobile devices.

A functionality of browser dependent extensions may be to realise or implement applications where the applications may implement or perform a wide variety of tasks and functions. However, applications provided in the form of browser dependent extensions have, at least in part, some or all of the problems mentioned hereinabove.

Thus, there is a need to provide an improved application program control on user devices. The present invention seeks to address, at least in part, some or all of the problems described hereinabove.

According to a first aspect of the present invention there is provided a method for operating a browser on a device comprising the steps of: receiving browser content from a server wherein the browser content includes at least one command; transmitting a first request to a port of the device based on the at least one command; receiving a response to the first request from an application on the device wherein the application monitors the port of the device and the response to the first request indicates the application is triggered; and transmitting a second request to the port wherein the second request indicates to the application that the browser will handover to the application.

Therefore, a device with a browser installed thereon, for example, a mobile telephone, tablet, laptop, notebook, set top box, or any other device with a browser may handover to an application wherein the application may be installed on the device. The browser may handover control of the device, for example, the browser may handover the Graphical User Interface, processing, memory, interfaces, user input controls, and so on. By handing over control of a device from a browser to an application on the device also means that the application is operating or executing independently of and outside the environment of the browser. Therefore, the application is not subject to the constraints or functionality of the browser, is not dependent on the type of browser and will not be terminated by termination of the browser.

Browser content, for example, a web page, HyperText Transfer Protocol (HTTP), or any other content that can be interpreted by a browser is received where the browser content includes at least one command.

The browser content may be pushed to the browser on the device or the browser may request the browser content from the server. Thus, the method may further comprise the step of transmitting a request to the server for the browser content. The request for browser content may be initiated by a user of the device wishing to access particular content, e.g. a particular web page.

Based on the at least one command a first request is transmitted to a port associated with an application. An application that may be triggered may be associated with one or more ports on the device. The application may be associated to a port by monitoring the port, listening to the port, watching the port, or any other terminology or function in order to receive or notice a communication, e.g. a request or connection, intended or addressed to the application.

The at least one command may instruct or cause the browser to transmit a request message to the port. The at least one command may identify the port that the application is monitoring, may identify the application (so that the device may identify the port from the identification of the application, e.g. locate the application in a database, index, or other means, to identify the associated port), or provide any other information that enables the port associated with the application be identified such that a request message may be transmitted to the port that is associated with the application.

The port may refer to a virtual port where each application installed on the device may request and/or be assigned a port on the device. A device may typically have an address, for example, an Internet Protocol (IP) address, to enable communications or connections to be made with the device. Typically, a device may have several applications installed thereon where each application may receive or transmit messages, data and so on, or establish a connection to a network or other device. As such, each application is associated with a port on the device (typically a virtual port) in order to provide a differentiator above the address of the device in order to identify the particular application on the device that a communication or connection relates to.

The first request may be a HTTP request to the identified port. In this example, the protocol used is HTTP, however, as a person skilled in the art will appreciate many of the embodiments of the present invention are not limited to HTTP but any number of protocols, e.g. Session Initiation Protocol (SIP), may be implemented where the protocol may provide the means to implement various messaging and request in accordance with many of the embodiments of the present invention.

A response to the first request is received from the application which may indicate that the application associated with, e.g. monitoring, listening to, the port has been triggered by the first request transmitted to the port.

A second request is transmitted to the port associated with the application which indicates to the application that the browser may handover to the application. Thus, the application may be informed that it effectively may take control of the device, in particular the functionality required by the application, e.g. GUI, interfaces, input/output control, and so on.

Accordingly, the method may advantageously enable a browser on a device to handover to an application such that the application may operate or execute outside of the control, environment and constraints of the browser that is installed on the device.

The application may be associated with the browser content. For example, the browser content may be any web asset, e.g. a web page, web site, online database, information, data, etc, and the application may be associated with the web asset. For example, a web page may be solely for the purpose of triggering an application, the application may be used to enhance all or part of the web site, the application may be chosen by a user, for example, the user clicking or selecting a link to an application, and so on. As a person skilled in the art will appreciate, there are many different ways and reasons for associating applications installed on a device with web assets obtained from a server.

The application on a device may be associated with a port (e.g. virtual port) on the device by assigning a port to the application. The assigned port for the application may be reported to the server. The server may inform the device as to the port to be assigned to an application. The server may determine the port to be assigned to the application. The application may request a port that is preconfigured or predefined in the application code when the application is being installed on the device wherein the server associated with the web asset associated with the application is also aware of the port to be requested and/or used by the application. The device may generate and/or maintain a table of installed applications and the associated port enabling the device to identify a port to assign to an application, for example, the next available port, a port that corresponds to the application according to the table, and/or based on application identification information. Certain types of application may use standardised or default port numbers, such as e-mail applications, file transfer applications, web browsing applications, and so on. As a person skilled in the art will appreciate, a port may be associated with an application installed on a device in many different ways.

The server may be a web server, an application server or any other server, or any combination thereof. The server may be any computing device that may perform the functions of a server.

The browser content may further include a second command and the method may further comprise the step of performing a periodic request to the server based on the second command wherein the periodic request is for updated browser content. Thus, once the browser receives the browser content the browser may perform a periodic request in accordance with the second command and periodically request after a predetermined time period (wherein the predetermined time period may be constant, variable or decaying time periods) updated browser content, e.g. an updated web page. The second command may further include an address for the server to which the periodic request is to be transmitted to, for example, the address may be a Uniform Resource Locator (URL).

The response to the first request received from the application may include a redirect request to the server; and the method may further comprise the step of performing a redirect request to the server based on the redirect request wherein the redirect request indicates to the server that the application has been triggered.

The redirect request may include a URL of the server to which the redirect request is to be transmitted. The URL may have been provided to the application in the first request, e.g. the URL may be included in the first request as a parameter, or the application may have a predefined or preconfigured URL included in the application code.

The method may further comprise the steps of receiving the updated browser content in response to the periodic request; requesting user input in response to the updated browser content; and receiving user input wherein the second request is transmitted in response to the received user input.

The updated browser content may include, for example, a request for user input so that the user of the device is aware that an application may take control outside of the browser environment and to prevent malicious applications taking control of the device. The request for user input may be, for example, a button to be displayed, a request for a key to be pressed, a request for touch screen input, and so on. As a person skilled in the art will appreciate, there are many different mechanisms for receiving user input to a device.

The user may provide the user input and, in response to positive user input, the second request, which indicates to the application that the browser will handover to the application, may be transmitted to the port associated with the application.

The server may respond to the periodic request to transmit updated browser content once the server received the redirect request from the browser. Thus, the updated browser content (e.g. an updated web page, etc) may be received once the server has received the redirect request which indicates to the server that the application has been triggered.

The method may further comprise the step of receiving a response to the second request from the application wherein the response triggers termination of the browser. Thus, in order for the handover to be completed the browser may be terminated.

To terminate the browser the response received to the second request from the application may include the instruction(s) necessary to terminate the browser.

Alternatively, the response received to the second request from the application may include a redirect request to the server and the server may provide the instruction(s) necessary to terminate the browser.

Therefore, the method may further comprise the steps of performing a redirect request to the server and receiving a response, e.g. new or updated browser content, wherein the new or updated browser content may include one or more commands to terminate the browser.

The method may further comprise the steps of receiving a command from the application wherein the command indicates that the application will handover to the browser; re-activating the browser based on the command; and transmitting a request to the server for browser content. Thus, once the application has finished its functionality or purpose the browser may be re-activated wherein the command to re-activate may include a URL for the server for browser content.

The URL may be preconfigured or predefined in the application or may be passed to application as, for example, a parameter, in any previous request, message, or other communication to the application.

According to a second aspect of the present invention there is provided an apparatus comprising: a first input adapted to receive browser content from a server wherein the browser content includes at least one command; a first output adapted to transmit a first request to a port of the device based on the at least one command; a second input adapted to receive a response to the first request from an application on the device wherein the application is associated with the port of the device and the response to the first request indicates the application is triggered; and a second output adapted to transmit a second request to the port wherein the second request indicates to the application that the browser will handover to the application.

According to a third aspect of the present invention there is provided an apparatus that is adapted to receive browser content from a server wherein the browser content includes at least one command; transmit a first request to a port of the device based on the at least one command; receive a response to the first request from an application on the device wherein the application monitors the port of the device and the response to the first request indicates the application is triggered; and transmit a second request to the port wherein the second request indicates to the application that the browser will handover to the application.

The apparatus may be a device. The device may be any device that may have a browser and/or an application stored or installed thereon. For example, the device may be a personal computer, laptop, tablet, mobile telephone, personal digital assistant, and so on.

The apparatus may further comprise a first processor adapted to perform a periodic request to the server based on a second command included in the received browser content wherein the periodic request is for updated browser content.

The apparatus may further comprise a third input adapted to receive the updated browser content in response to the periodic request; a third output adapted to request user input in response to the updated browser content; and a fourth input adapted to receive user input wherein the second request is transmitted in response to the received user input.

The apparatus may further comprise a second processor adapted to perform a redirect request to the server based on a redirect request included in the response to the first request wherein the redirect request indicates to the server that the application has been triggered.

The apparatus may further comprise a fifth input adapted to receive a response to the second request from the application wherein the response triggers termination of the browser.

The apparatus may further comprise a sixth input adapted to receive a command from the application wherein the command indicates that the application will handover to the browser; a fourth processor adapted to re-activate the browser based on the command; and a third output adapted to transmit a request to the server for browser content.

The apparatus may be adapted by or may include any hardware (e.g. processors, inputs, outputs, memory, and so on), software or any combination thereof in order to implement or carry out any of the embodiments of the present invention.

The first input to sixth inputs may be the same input, different inputs or any combination thereof. The inputs may be implemented in hardware, software or any combination thereof.

The first output to third output may be the same output, different outputs or any combination thereof. The outputs may be implemented in hardware, software or any combination thereof.

The first to fourth processor may be the same processor, different processors or any combination thereof. The processors may be implemented in hardware, software or any combination thereof.

According to a fourth aspect of the present invention there is provided a computer program product comprising computer readable executable code for: receiving browser content from a server wherein the browser content includes at least one command; transmitting a first request to a port of the device based on the at least one command; receiving a response to the first request from an application on the device wherein the application is associated with the port of the device and the response to the first request indicates the application is triggered; and transmitting a second request to the port wherein the second request indicates to the application that the browser will handover to the application.

The computer program product may further comprise computer readable executable code for performing any or all of the functions in accordance with the aspects of the invention.

According to a fifth aspect of the present invention there is provided a method of operating an application on a device comprising the steps of: monitoring a port on the device; receiving a first request from a browser on the device via the monitored port wherein the first request triggers the application; transmitting a response to the first request to the browser wherein the response indicates that the application has been triggered; and receiving a second request from the browser wherein the second request indicates that the browser will handover to the application.

The application may be associated with browser content in the browser.

The response to the first request may include a redirect request to a server. The response may further include a URL for the server. The URL may have been received in the first request or the URL may be predefined or preconfigured in the application.

The method may further comprise the step of transmitting a response to the second request to the browser wherein the response to the second request triggers termination of the browser.

The method may further comprise generating a command to re-activate the browser. The method may further comprise transmitting the command to the device and/or browser. The command to re-activate the browser may further include a URL for browser content from the server.

The method may further comprise requesting a predefined port on the device.

According to a sixth aspect of the present invention there is provided an apparatus comprising: a processor adapted to monitor a port on the device; a first input adapted to receive a first request from a browser on the device via the monitored port wherein the first request triggers the application; a first output adapted to transmit a response to the first request to the browser wherein the response indicates that the application has been triggered; and a second input adapted to receive a second request from the browser wherein the second request indicates that the browser will handover to the application.

According to a seventh aspect of the present invention there is provided an apparatus adapted to: monitor a port on the device; receive a first request from a browser on the device via the monitored port wherein the first request triggers the application; transmit a response to the first request to the browser wherein the response indicates that the application has been triggered; and receive a second request from the browser wherein the second request indicates that the browser will handover to the application.

The apparatus may be a device. The device may be any device that may have a browser and/or an application stored or installed thereon. For example, the device may be a personal computer, laptop, tablet, mobile telephone, personal digital assistant, and so on.

The application may be associated with browser content in the browser. The response to the first request may include a redirect request to a server.

The apparatus may further comprise a second output adapted to transmit a response to the second request to the browser wherein the response to the second request may trigger termination of the browser.

The apparatus may further comprise a third output adapted to transmit a command to re-activate the browser.

The apparatus may be adapted by or may include any hardware (e.g. processors, inputs, outputs, memory, and so on), software or any combination thereof in order to implement or carry out any of the embodiments of the present invention.

The first input and second input may be the same input or different inputs. The inputs may be implemented in hardware, software or any combination thereof.

The first output to third output may be the same output, different outputs or any combination thereof. The outputs may be implemented in hardware, software or any combination thereof.

According to an eighth aspect of the present invention there is provided a computer program product comprising computer readable executable code for: monitoring a port on the device; receiving a first request from a browser on the device via the monitored port wherein the first request triggers the application; transmitting a response to the first request to the browser wherein the response indicates that the application has been triggered; and receiving a second request from the browser wherein the second request indicates that the browser will handover to the application.

The computer program product may further comprise computer readable executable code for performing any or all of the functions in accordance with the aspects of the invention.

According to a ninth aspect of the present invention there is provided a device, wherein the device operatively connects to a server and the device comprises a browser and an application, in which: the application monitors a port on the device; the browser receives browser content from the server wherein the browser content includes at least one command; the browser transmits a first request to the port of the device based on the at least one command; the application receives the first request from the browser via the monitored port wherein the first request triggers the application; the application transmits a response to the first request to the browser; the browser receives the response to the first request from the application wherein the response to the first request indicates the application is triggered; the browser transmits a second request to the port; and the application receives the second request from the browser wherein the second request indicates that the browser will handover to the application.

The device may further comprise installing the application on the device and assigning a port to the application such that the application monitors the assigned port.

The device may comprise any hardware, software or any combination thereof in order to implement or carry out any or all of the embodiments of the present invention.

Embodiments of the present invention will now be described, by way of example only and with reference to the accompanying drawings, in which:

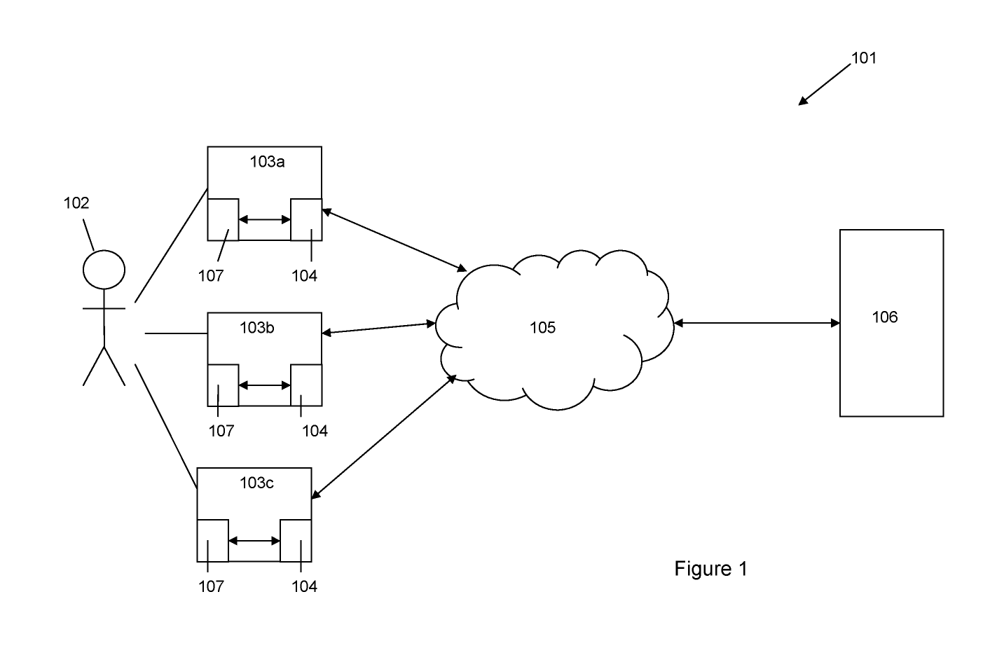

FIG. 1 shows a simplified block diagram of a system in accordance with many embodiments of the present invention.

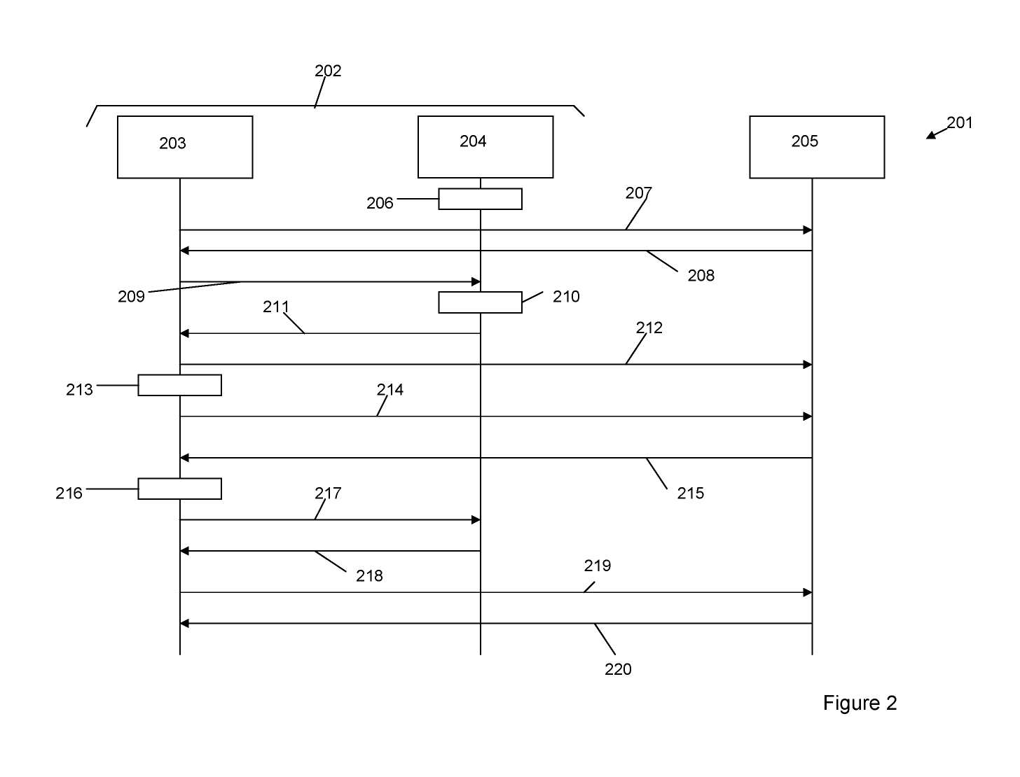

FIG. 2 shows a message flow diagram in accordance with many embodiments of the present invention.

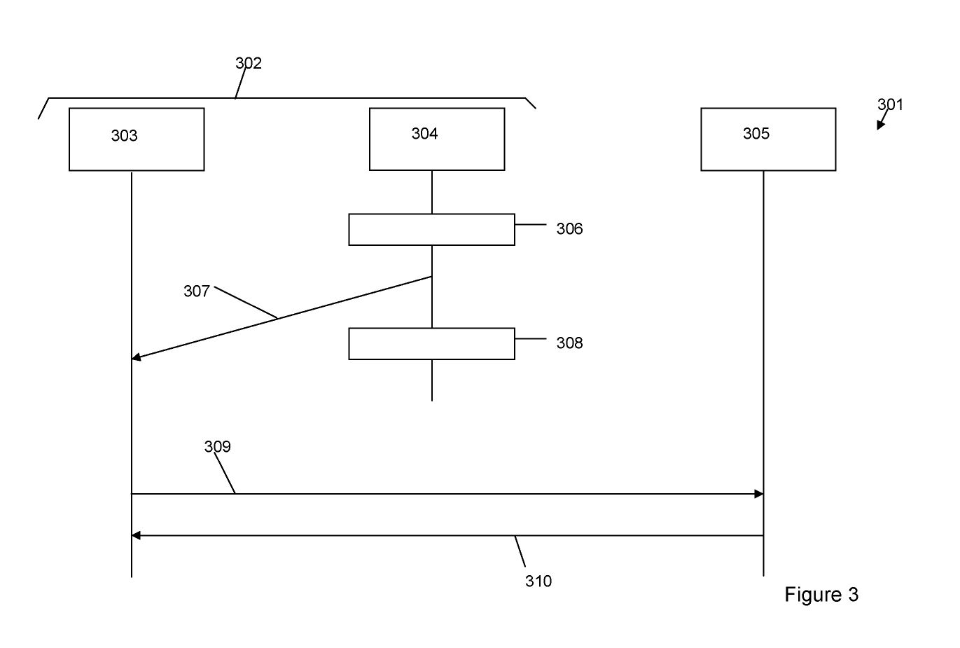

FIG. 3 shows a message flow diagram in accordance with many embodiments of the present invention.

FIG. 1 shows a simplified block diagram of a system 101 in accordance with many embodiments of the present invention. A user 102 may have one or more user devices 103, for example, a computing device 103a (personal computer, laptop, set-top box, and so on) and mobile devices 103b, 103c (mobile telephone, a tablet, a Personal Digital Assistant, and so on). The user devices 103 include one or more browsers 104 which provide the user 102 of the user device various functionality such as browsing the Internet, browsing other networks (e.g. intranets), browsing file structures, and so on. The device also includes ports 107, wherein the ports 107 may be virtual ports or physical ports that enable applications or other components to receive and transmit communications. Thus, as will be appreciated, any type of user device may be used by a user where the user device includes one or more browsers installed thereon.

A typical function of a browser 104 is to enable the user 102, via their user device 103, to view and interact with web assets, e.g. data, information, programs, feeds, and resources in the Internet 105. Typically, the web assets will be displayed in the browser in the form of browser content such as web pages or other content, which are requested by the browser 104 from a web server 106 and provided over a network such as the Internet 105.

As mentioned hereinabove, browsers often include or utilise browser extensions or plug-ins in order to provide greater functionality and to further enhance the user experience by, for example, executing applications, provide enhanced graphics, and so on.

However, as described above the browser extensions operate within the browser environment and are specific to each browser. Therefore if the browser is terminated all functionality being provided by the browser extensions are also terminated. Furthermore, as the browser extensions are browser specific then some functionality provided by one browser may not be available to another browser. Similarly, browsers on mobile devices often do not include the browser extensions that may be available to the same browser on a computing device such as a personal computer, laptop, set top box, and so on as often browsers on mobile devices include reduced functionality.

An example in accordance with many of the embodiments of the present invention will now be described with reference to FIG. 2.

The example given below is in relation to application program control, in particular, by a browser on a mobile device, for example, a mobile telephone. However, as will be appreciated, the application program control of many of the embodiments of the present invention may be applied to other devices such as personal computers, laptops, tablets, and so on. Also, in the specific example given below the application is a Java Midlet and the communication between the browser, the application and the server is based on Hyper-Text Transfer Protocol (HTTP). However, as will be appreciated the application may be any type, format or language of application, and the communication between the browser, the application and the server may be based on any type, format or protocol that can be used to implement the application program control of the embodiments of the present invention.

FIG. 2 shows a simplified message flow diagram 201 in accordance with many embodiments of the present invention.

A mobile device 202 may include a browser 203 and an application 204. The application 204 may be associated with web assets, for example, web content (e.g. web pages, web sites, information, data, and so on), stored on a server 205 and provided as browser content to the browser by the server 205. The server 205 may be a web server, an application server, or any type of server or computing device that the mobile device 202 may operatively connect to in order to request and receive web assets associated with the application 204 installed on the mobile device 202. The mobile device 202 may operatively connect to the server 205 via at least one network, e.g. an access network, a wide area network, a local area network, the Internet, and so on via wireless and/or fixed communication channels.

An application 204 may be installed on the mobile device 202. The application 204 may be requested (e.g. pulled) from a server (which may be the server 205 in FIG. 2 or another server) and installed on the mobile device 202. Alternatively, the application 204 may be pushed onto the mobile device 202 and installed thereon. In this case, the trigger for pushing the application 204 onto the mobile device 202 may be in response to the user requesting, via the browser 203 on the mobile device 202, a particular web asset, e.g. web page, information, data, etc., from the server 205 where the application is associated with the requested web asset.

The application 204 installed on the mobile device 202 may be assigned a port to listen to, watch or monitor in order to identify or determine when the application 204 is to be triggered. For example, a request may be sent to a particular port on the mobile device 202 associated with the application 204 in order to trigger the application 204 on the mobile device 202.

There may be several applications installed on the mobile device 202 where each application may be associated with a different port on the device, e.g. assigned a different port to listen to or monitor.

In the example shown in FIG. 2, at step 206 an application 204 may be installed on the mobile device 202 and assigned a port to listen to or monitor. As mentioned hereinabove, in this example the application 204 is a Java Midlet and as such the installed application 204 may be registered using a Push Registry mechanism which enables the Java Midlet 204 to register itself on the mobile device 202 such that it may be triggered when the mobile device 202 receives communication for the Java Midlet 204 to the port associated with the Java Midlet 204. As described hereinabove, the application 204 may request a particular preconfigured port, maybe assigned a port by the mobile device based on ports available, the type of application 204 or instructions from an associated server. In this example, the Java Midlet 204 is assigned to port 5000 on the mobile device 202 using the Java command:

connector.open(“socket://:5000”);

However, as a skilled person in the art will appreciate, utilising Java and the Push Registry mechanism is one of a variety of different mechanisms that may be utilised to install an application on any device and to assign a port on that device.

A web asset, which in this example will be a web page, may be requested 207 from a server 205 by the browser 203 on the mobile device 202. In this example, the web page may be requested via a HyperText Transfer Protocol (HTTP) request 207. The server 205 may identify or determine that an application 204, e.g. the Java Midlet 204, is associated with the requested web page and identify that, in this example, the device is a mobile device 202.

The server 205 may identify that the Java Midlet 204 associated with the web page is installed on the mobile device 202 or may prompt the installation of the associated java Midlet 204.

The server 205 responds 208 to the received request by transmitting a web page (or other web asset) in the form of browser content to the web browser 203 on the mobile device 202. The response 208 of browser content may include one or more commands, instructions or an indication that the Java Midlet 204 is to be triggered by the browser 203 on the mobile device 202. In this example, the handover of control of the mobile device 202 to the Java Midlet 204 is initiated by the browser 203 on receipt of the web page provided by the server 205.

The web asset, in this case the requested web page, will be provided as browser content to the browser 203 on the mobile device 202 so that the browser can interpret the web page and act accordingly, e.g. display the web page, perform a function based on commands in the browser content, and so on.

The browser content (e.g. the web page) received by the browser 203 may include a first part that defines a periodical request to a predefined Uniform Resource Locator (URL) of the server 205. The first part may, for example, be implemented using AJAX in Javascript. The received browser content may further include a second part that defines or includes a request to the port that the java Midlet 204 associated with the web page is monitoring or listening to. The second part may, for example, be implemented using an embedded Inline Frame (IFrame).

In this example, the associated Java Midlet 204 is monitoring or listening to port 5000 and therefore the request included in the second part will be to port 5000 on the mobile device 202.

The browser content may further include one or more parameters, for example, it may include the URL of the server 205 associated with the Java Midlet 204 on the mobile device 205, or any other information or data relevant to the java Midlet 204, the triggering of the Java Midlet 204 or the execution of the Java Midlet 204.

On receiving the browser content from the server 205, the browser 203 on the mobile device 202 processes or interprets the browser content.

Based on the first part of the received browser content a periodical request is triggered or initiated to a predefined URL, which in this example is the URL of the server 205. Therefore, each time a periodical timer expires, a request for updated browser content (e.g. an updated web page) is transmitted to the URL. This process continues until a response is received to the periodical request from the server 205. As will be discussed below, the server 205 may not respond to the periodical request until the server 205 receives an indication that the application 204 has been triggered.

Based on the second part of the received browser content, the IFrame triggers or initiates a HTTP request to port 5000 209 on the mobile device 202. As described hereinabove, in this example the Java Midlet 204 associated to the requested web page from the server 205 is associated with port 5000 in that the Java Midlet 204 is monitoring or listening to port 5000 on the mobile device 202. The HTTP request to port 5000 209 may also include one or more parameters to provide any information or data that the Java Midlet 204 requires in order to trigger or execute the Java Midlet 204.

The Java Midlet 204 monitoring or listening to port 5000 on the mobile device 202 receives or notices the HTTP request 209 which triggers the Java Midlet 204 to start executing or running 210. However, the Java Midlet 204 may not initialise its Graphical User Interface (GUI) or control other aspects of the mobile device 202 until the handover of control from the browser 203 to the Java Midlet 204 is completed.

The Java Midlet 204 responds to the HTTP request 209 by transmitting a HTTP response 211 to the browser 203, where the HTTP response 211 may include a redirect request and may, for example, relate to or include a HTTP 302 status code which is typically used to indicate that a service is currently available at a different location. The HTTP status code 302 response is used to make the browser 203 perform a redirect function. As will be appreciated, one or more other HTTP status codes may alternatively be used to force the browser to perform a redirect to the associated server 205.

The HTTP 302 response 211 from the application 204 may include a URL of the server 205 as the destination of the redirect request. The Java Midlet 204 may be pre-configured with a URL of the server 205 associated with the Java Midlet 204 or the HTTP request 209 to port 5000 assigned to the Java Midlet 204 may include, for example as a parameter, the URL of the server 205.

The browser 203 on receipt of the HTTP response 211 from the Java Midlet 204 performs the HTTP redirect request 212 to the URL of the server 205. The URL may include parameters to inform or indicate to the server 205 that the Java Midlet 204 has been triggered or initiated. For example, the HTTP redirect request 212 may be to:

http://seRver_address/ping&id=123.

The HTTP redirect request 212 transmitted to the server 205 by the browser 203 indicates to the server 205 that the Java Midlet 204 on the mobile device 202 has been triggered and may also indicate to the server 205 that it should respond to the periodical request that was activated when the browser 203 received the original web page, in the form of browser content, from the server 205 in step 208. Accordingly, the next time the periodical request timer expires 213 and the periodical request, which in this example is a request for a web page update from the server 205, is transmitted 214 to the server 205 then the server 205 responds 215 with a web page update, in the form of new or updated browser content.

In this example, the updated browser content transmitted 215 from the server 205 to the browser 203 includes a graphical button which is to be displayed in the browser 203. The browser content update 215 therefore updates the current web page being displayed in the web browser 203 to include the graphical button which invites or indicates to the user of the mobile device 202 to provide an input.

The browser 203 may then receive input from a user in the form of the button displayed in the browser 203 being selected or clicked by the user using the mobile device 202.

In this example, a graphical button is displayed to the user in a web browser however, as will be appreciated, any other means of requesting user input may be used, for example, via a selectable link, any other graphic or icon to select or click, request a key on the device is pressed (e.g. a request that the number 1 key is pressed), a touch screen input, and so on.

User input may be requested in order to receive an acknowledgement from the user that the application is to be executed and that the application is to take over control of the user device from the browser. The acknowledgement may be used to ensure that unwanted or malicious applications are not triggered or executed automatically and that all applications which are executed outside of the browser environment are wanted by the user. Furthermore, by requesting user input before a handover from the browser to the application may also provide an indication to the user that the application may now take control of the GUI on the device and that the user will therefore no longer be interacting with the browser.

Alternatively, user input may not be requested and therefore, instead of user input a delay time period may be initiated, or the handover of control from the browser to the application may continue automatically, or the process may only continue if, for example, security checks are positive (e.g. determining if security certificates are correct), and so on.

As described hereinabove, in this example a graphical button is displayed on a web page in the browser 203 and the user selects, via a user input mechanism on the mobile device 202, the graphical button, for example, by clicking or selecting the button, in order to acknowledge the triggering of the Java Midlet 204. The user may also be presented with one or more pieces of information, where the information may relate to the Java Midlet 204, for example, one or more of the purpose, function, provider, and so on of the application 204, so that the user is aware of the Java Midlet 204 that is to be triggered and executed on the mobile device 202.

A HTTP request 217 is triggered to port 5000 on the mobile device 202 associated with the triggered Java Midlet 204. The HTTP request 217 to port 5000 indicates to the Java Midlet 204 that it can now activate, initiate or execute its GUI on the display of the mobile device 202 and/or take control of any other function of the mobile device 202, e.g. input/output, and so on. In order to complete the handover of control from the browser 203 to the Java Midlet 204, the Java Midlet 204 may then trigger the termination or closing of the browser 203 on the mobile device 202.

In this example, the Java Midlet 204 triggers the closing or termination of the browser 203 on the mobile device 202 by responding to the HTTP request 217 with, for example, a HTTP 302 response 218 where the 302 response indicates that a service is temporarily moved thereby causing the browser 203 to perform a redirect function to the server 205. As will be appreciated, several different HTTP status codes may alternatively be used to force the browser 203 to perform a redirect to the associated server 205.

The HTTP 302 response 218 from the Java Midlet 204 may include a URL of the server 205. The Java Midlet 204 may be pre-configured with a URL of the server 205, the HTTP request to port 5000 217 may include the URL of the server 205 as a parameter in the request, or the URL of the server 205 may be included in a parameter of a previous communication received by the Java Midlet 204.

The browser 203 on receipt of the HTTP response 218 from the Java Midlet 204 performs a HTTP redirect request 219 to the URL of the server 205. The URL may include parameters to inform or indicate to the server 205 that the Java Midlet 204 is active or executing and that the browser 203 on the mobile device 202 may be closed or terminated in order to complete the handover of control from the browser 203 to the Java Midlet 204. For example, the HTTP redirect request may be to:

http://server_address/ping&id=123

In response to the HTTP redirect request 219 transmitted to the server 205 by the browser 203, the server 205 responds to the browser 203 with a HTTP response 220 that includes a command or instruction to close or terminate the browser 203. For example, the HTTP response 220 may include the command:

onload=”javascript:window:close( );
in order to close the browser 203.

However, as will be appreciated other commands or instructions may be utilised by the server 205 to close or terminate the browser 203 or move the browser process into the background on the mobile device 202.

Alternatively, instead of utilising a HTTP redirect to trigger the server 205 to close or terminate the browser 203, the Java Midlet 204 may perform the necessary steps to terminate or close the browser 203 on the mobile device 202. For example, after receiving the HTTP request 217 to port 5000, the Java Midlet 204 may respond to the request 217 with Hyper Text Markup Language (HTML) code to close the browser 203. In this example, the HTML code may include:

```
<HTML>
  <HEAD>....</HEAD>
    <BODY onload = “window.close( );” />
</HTML>
```

Thus, in many of the embodiments, under the control of the browser on the device an application has been triggered and a handover of control of the mobile device 202, for example, control of the GUI, from the browser to the application has been performed.

Accordingly, in many of the embodiments a browser on a device can hand over control of the device to an application installed on the device. Advantageously, the application can therefore operate and execute outside the constraints and environment of the browser as well as utilise the functionality and control of the device on which the application is installed. In the examples described hereinabove, the application was a Java Midlet, the device was a mobile device and the requests/responses were based on HTTP, however as will be appreciated, the application may be any application, the device may be any device on which applications and browsers may be installed and the requests/responses may be based on any protocol that enables the application to be triggered and the handover of control from the browser to the application to be performed.

The process of returning control to the browser and handing over the GUI once the application has finished performing its specified tasks will now be described with reference to FIG. 3.

FIG. 3 shows a simplified message flow diagram 301 in accordance with many embodiments of the present invention.

As with the above described examples, in this example the device 302 is the mobile device, the application 304 is the Java Midlet, the browser 303 and the server 305 are all the same as those described in relation to FIG. 2 and therefore are not further defined here.

Prior to the termination of the Java Midlet 304, for example, once the Java Midlet 304 has completed its task, the Java Midlet 304 should handover control of the mobile device 302, e.g. the GUI, back to the browser 303.

In the present example, the Java Midlet 304, triggers the restart 307 of the browser 303 by, for example, executing 306, on the mobile device 302, a command:

system.execute(http://server/finish&id=123);

The URL forming part of the above command may have been preconfigured in the Java Midlet 304 or may have been passed or provided in a parameter of one of the previously described requests to the port on the device that the Java Midlet 304 is associated with, e.g. listening to or monitoring. The URL may be the URL of the server 305 to which the re-started browser 303 is to be directed to. However, as will be appreciated the URL could be any URL that the re-started browser is to be initially directed to.

Once the Java Midlet 304 has triggered the re-start of the browser 303 the Java Midlet 304 may terminate itself if the application environment on the mobile device 302 enables the application 304 to be registered as and continue to monitor or listen to the assigned port without the application 304 needing to be running or executing on the mobile device 302. Alternatively, the Java Midlet 304 may remain active, e.g. executing or running in the background on the mobile device 302, if the application environment requires the application 304 to be active in some respect in order to continue to monitor or listen to the assigned port.

In the case that the Java Midlet 304 can be terminated then the Java Midlet 304 itself will execute the command 308 on the mobile device 302:

system.exit(0);

Thus, the Java Midlet 304 may terminate itself if it can passively continue to monitor or listen to the port associated with, e.g. assigned to, that application.

Once the Java Midlet 304 has triggered the re-start of the browser 303, the browser 303 transmits a HTTP request 309 to the URL of the server 305 included in the command 306 which activated 307 the browser 303. The server 305 may then transmit a HTTP response 310 to the browser 303.

Accordingly, in many of the embodiments, a device with a browser installed thereon, for example, a mobile telephone, tablet, laptop, notebook, set top box, or any other device with a browser may handover to an application wherein the application may be installed on the device. The browser may handover control of the device, for example, the browser may handover the Graphical User Interface, processing, memory, interfaces, user input controls, and so on. By handing over control of a device from a browser to an application also means that the application is operating or executing independently of and outside the environment of the browser. Therefore, the application is not subject to the constraints or functionality of the browser, is not dependent on the type of browser and will not be terminated by termination of the browser.

In many of the embodiments the device is a mobile telephone but, as described hereinabove, may be a set top box, a laptop, notebook, and so on. In other words, the device may be any device on which a browser is installed and may operatively connect to a server.

In many of the embodiments the communication between the browser, the application and the server is based on HTTP but may equally be based on any protocol or communication language that is suitable for transmitting and receiving browser content and requests.

In many of the embodiments, the browser content, requests and responses may include any number of parameters or control information in order to control the handover from the browser to the application or to control the execution of the browser or the application.

While preferred embodiments of the invention have been shown and described, it will be understood that such embodiments are described by way of example only. Numerous variations, changes and substitutions will occur to those skilled in the art without departing from the scope of the present invention as defined by the appended claims. Accordingly, it is intended that the following claims cover all such variations or equivalents as fall within the spirit and the scope of the invention.

1. A method for operating a browser on a device comprising the steps of:
receiving browser content from a server wherein said browser content includes at least one command;
transmitting a first request to a port of said device based on said at least one command;
receiving a response to said first request from an application on said device wherein said application is associated with said port of said device and said response to said first request indicates said application is triggered; and
transmitting a second request to said port wherein said second request indicates to said application that said browser will handover to said application.

2. The method as claimed in in which said browser content includes a second command and said method further comprises the step of:
performing a periodic request to said server based on said second command wherein said periodic request is for an updated browser content.

3. The method as claimed in claim 2 further comprising the steps of:
receiving said updated browser content in response to said periodic request;
requesting user input in response to said updated browser content; and
receiving user input wherein said second request is transmitted in response to said received user input.

4. The method as claimed in claim 1 in which said response to said first request includes a redirect request to said server; and said method further comprises the step of:
performing a redirect request to said server based on said redirect request wherein said redirect request indicates to said server that said application has been triggered.

5. The method as claimed in claim 1, further comprising the step of:
receiving a response to said second request from said application wherein said response triggers termination of said browser.

6. The method as claimed in claim 1, further comprising the steps of:
receiving a command from said application wherein said command indicates that said application will handover to said browser;
re-activating said browser based on said command; and
transmitting a request to said server for browser content.

7. An apparatus comprising:
a first input adapted to receive browser content from a server wherein said browser content includes at least one command;
a first output adapted to transmit a first request to a port of said device based on said at least one command;
a second input adapted to receive a response to said first request from an application on said device wherein said application is associated with said port of said device and said response to said first request indicates said application is triggered; and
a second output adapted to transmit a second request to said port wherein said second request indicates to said application that said browser will handover to said application.

8. The apparatus as claimed in claim 7 further comprising:
a first processor adapted to perform a periodic request to said server based on a second command included in said received browser content wherein said periodic request is for updated browser content.

9. The apparatus as claimed in claim 8 further comprising:
a third input adapted to receive said updated browser content in response to said periodic request;
a third output adapted to request user input in response to said updated browser content; and
a fourth input adapted to receive user input wherein said second request is transmitted in response to said received user input.

10. The apparatus as claimed in claim 7, further comprising:
a second processor adapted to perform a redirect request to said server based on a redirect request included in said response to said first request wherein said redirect request indicates to said server that said application has been triggered.

11. The apparatus as claimed in claim 7, further comprising:
a fifth input adapted to receive a response to said second request from said application wherein said response triggers termination of said browser.

12. The apparatus as claimed in claim 7, further comprising:
a sixth input adapted to receive a command from said application wherein said command indicates that said application will handover to said browser;
a fourth processor adapted to re-activate said browser based on said command; and
a third output adapted to transmit a request to said server for browser content.

13. A computer program product comprising computer readable executable code for:
receiving browser content from a server wherein said browser content includes at least one command;
transmitting a first request to a port of said device based on said at least one command;
receiving a response to said first request from an application on said device wherein said application is associated with said port of said device and said response to said first request indicates said application is triggered; and
transmitting a second request to said port wherein said second request indicates to said application that said browser will handover to said application.

14. A method of operating an application on a device comprising the steps of:
monitoring a port on said device;
receiving a first request from a browser on said device via said monitored port wherein said first request triggers said application;
transmitting a response to said first request to said browser wherein said response indicates that said application has been triggered; and
receiving a second request from said browser wherein said second request indicates that said browser will handover to said application.

15. The method as claimed in claim 14 in which said application is associated with browser content in said browser.

16. The method as claimed in claim 14 in which said response to said first request includes a redirect request to a server.

17. The method as claimed in claim 14, further comprising the step of:
transmitting a response to said second request to said browser wherein said response to said second request triggers termination of said browser.

18. The method as claimed in claim 14, further comprising the step of:
transmitting a command to re-activate said browser.

19. An apparatus comprising:
a processor adapted to monitor a port on said device;
a first input adapted to receive a first request from a browser on said device via said monitored port wherein said first request triggers said application;
a first output adapted to transmit a response to said first request to said browser wherein said response indicates that said application has been triggered; and
a second input adapted to receive a second request from said browser wherein said second request indicates that said browser will handover to said application.

20. The apparatus as claimed in claim 19 further comprising:
a second output adapted to transmit a response to said second request to said browser wherein said response to said second request triggers termination of said browser.

21. The apparatus as claimed in claim 19 further comprising:
a third output adapted to transmit a command to re-activate said browser.

22. A computer program product comprising computer readable executable code for:
monitoring a port on said device;
receiving a first request from a browser on said device via said monitored port wherein said first request triggers said application;
transmitting a response to said first request to said browser wherein said response indicates that said application has been triggered; and
receiving a second request from said browser wherein said second request indicates that said browser will handover to said application.

23. A device, wherein said device operatively connects to a server and said device comprises a browser and an application, in which:
said application monitors a port on said device;
said browser receives browser content from said server wherein said browser content includes at least one command;
said browser transmits a first request to said port of said device based on said at least one command;
said application receives said first request from said browser via said monitored port wherein said first request triggers said application;
said application transmits a response to said first request to said browser;
said browser receives said response to said first request from said application wherein said response to said first request indicates said application is triggered;
said browser transmits a second request to said port; and
said application receives said second request from said browser wherein said second request indicates that said browser will handover to said application.
